(19) United States
(12) Patent Application Publication
(10) Pub. No.: US 2018/0239889 A1
(43) Pub. Date: Aug. 23, 2018

(54) VALIDATING HUMAN INPUT DEVICES WHEN CONNECTED TO A COMPUTER

(71) Applicant: Microsoft Technology Licensing, LLC, Redmond, WA (US)

(72) Inventor: Matthew Burrough, Redmond, WA (US)

(21) Appl. No.: 15/437,604

(22) Filed: Feb. 21, 2017

(51) Int. Cl. G06F 21/44; G06F 21/83

(52) U.S. Cl. CPC G06F 21/44; G06F 21/83

(57) ABSTRACT

A computer reduces the likelihood that an input device connected to a port can perform unauthorized actions by verifying that the input device is a valid human input device before accepting inputs from that input device as a human input device. In response to the input device being connected to the computer, the computer invokes a device driver which validates the input device as a human input device before any input requests can be passed from the input device to other components of the computer. When the device driver begins operation, the device driver prompts the user to confirm that the input device is a human input device. If input from the user confirms that the device is a human input device, then the device driver can begin passing input requests from the input device to other components of the computer.

### BACKGROUND

Most modern computers include one or more ports for connecting the computer to external devices. Such ports generally have a physical form factor that conforms to an established standard or to a proprietary specification. Also, the computer typically has a driver that implements a protocol for communication between the personal computer and any external device connected to the port. Some ports support external devices that are human input devices. Examples of such ports include, but are not limited to, versions or types of a Universal Serial Bus (USB) port, a FireWire (IEEE-1394) port, a PS/2 serial port, a THUNDERBOLT port, and a Peripheral Component Interconnect (PCI) port, to name a few.

Some of these kinds of ports, such as USB ports, allow multiple different types of devices to be connected to a port. For example, both storage devices and human input devices, such as keyboards and mouse devices, can be connected to a USB port of a computer. The protocols used by some kinds of ports, such as USB ports, allow for what is called a “plug and play” behavior. This means that, in response to a physical connection being made between the port of the computer and a device, the computer automatically executes an appropriate driver based on a type of the device, and immediately starts responding to any inputs from the device, without further intervention by the user.

Such plug and play behavior, on a port on which the computer can receive inputs from a human input device, provides a mechanism through which malicious code can be introduced into, and executed on, the computer. An unaware user may believe that he or she has, for example, a storage device, such as a USB storage device, when connecting a device to a computer. Or, an individual with malicious intent may have a device that appears to be, for example, storage device, such as a USB storage device, that he or she connects to a computer. In fact, the apparent storage device may be configured to behave as a keyboard device, or other human input device, which, upon connection to the computer, begins sending a predetermined stream of commands, such as keyboard inputs, to the computer. This stream of commands can be designed to introduce malicious code into the computer.

### SUMMARY

This Summary is provided to introduce a selection of concepts in a simplified form that are further described below in the Detailed Description. This Summary is intended neither to identify key or essential features, nor to limit the scope, of the claimed subject matter.

A computer can reduce the likelihood that an input device connected to a port can introduce malicious code, or perform other unauthorized actions, by verifying that the input device is a valid human input device before accepting any inputs from that input device as a human input device. In response to the input device being connected to the computer, the computer invokes a device driver which validates the input device as a human input device before any input requests can be passed from the input device to any other component of the computer. When the device driver begins operation, the device driver first prompts the user to confirm that the input device is a human input device. If input from the user confirms that the device is a human input device, then the device driver can begin passing input requests from the input device to other components of the computer. For example, in response to a confirmation that the input device is a human input device, the device driver can enter a state in which the device driver passes input requests from the human input device to other components of the computer. Until the device driver makes such a confirmation, any input requests from the input device can be ignored. If the input device is not confirmed to the device driver, e.g., a confirmation is not received in time, or a confirmation is not successful within a set number of attempts, or the input device is expressly blocked, the device driver can ignore all further input requests from the input device. For example, in response to an input indicating an input device should be blocked, the device driver can enter a state in which all further input requests from that input device are ignored.

The device driver can direct the operating system to output a prompt to an output device connected to the computer, and wait for an input from any input device indicating that the user either accepts or rejects the newly connected input device.

The device driver can direct the operating system to output a prompt to an output device connected to the computer, and wait for a specific kind of input from the newly connected input device. For example, if the device type reported by the input device is a “keyboard”, then the prompt can direct a user to enter a sequence of keystrokes through the input device. If the input device is not in fact a keyboard, then entering the directed sequence of keystrokes would not be possible. The sequence of keystrokes can be randomly generated. The device driver, or other component of the computer, or another computer, can randomly generate the sequence of keystrokes. The sequence of keystrokes can be generated before or after the input device is connected to the computer. A limit on the number of unsuccessful attempts, and/or a time limit, can be imposed for the directed sequence of keystrokes to be entered.

The device driver also can monitor inputs from a human input device and, based on heuristics of those inputs, determine whether to continue processing inputs from the human input device.

The device driver can have access to information describing approved human input devices. In some instances, a human input device may provide a serial number or other uniquely identifying information to the device driver. If such information is provided by a new human input device, and the device driver can compare this information to a list of approved human input devices, then the validation module can use this information to determine whether to accept the new human input device.

In the following description, reference is made to the accompanying drawings which form a part hereof, and in which are shown, by way of illustration, specific example implementations. Other implementations may be made without departing from the scope of the disclosure.

### BRIEF DESCRIPTION OF THE DRAWINGS

FIG. 1 is a block diagram of an example computer.

FIGS. 2A-2D are block diagrams of example implementations of an operating system of a computer.

FIG. 3 is a data flow diagram of an illustrative example implementation of a filter driver that performs verification.

FIG. 4A is a flow chart illustrating operation of an example implementation of an operating system.

FIG. 4B is a flow chart illustrating operation of an example implementation of a device driver that performs verification.

FIG. 5 is an illustrative example of display data for a prompt for user input.

FIG. 6 is an illustrative example of display data for a prompt for user input.

### DETAILED DESCRIPTION

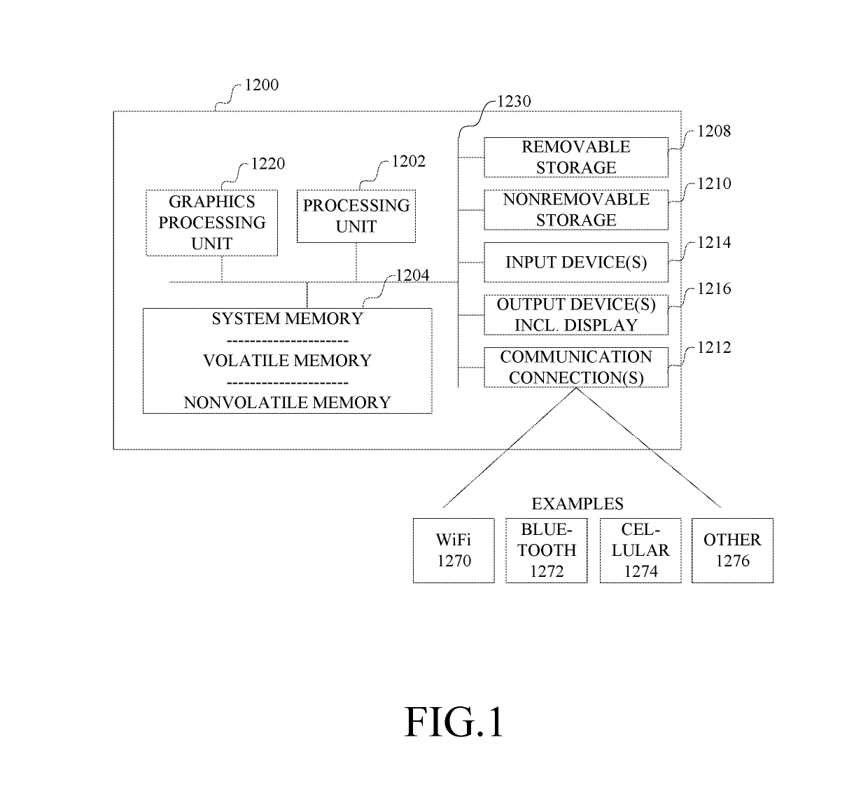

FIG. 1 illustrates an example of a general-purpose computer in which techniques to validate human input devices can be implemented. FIG. 1 illustrates only one example of a computer and is not intended to suggest any limitation as to the scope of use or functionality of such a computer. The computer can be any of a variety of general-purpose or special-purpose computing hardware configurations. Some examples of types of computers that can be used include, but are not limited to, personal computers, game consoles, set top boxes, hand-held or laptop devices (for example, media players, notebook computers, tablet computers, cellular phones including but not limited to “smart” phones, personal data assistants, voice recorders), server computers, multiprocessor systems, microprocessor-based systems, programmable consumer electronics, networked personal computers, minicomputers, mainframe computers, and distributed computing environments that include any of the above types of computers or devices, and the like.

Regarding FIG. 1, a computer 1200 includes a processing system comprising at least one processing unit 1202 and at least one memory 1204. The processing unit 1202 can include multiple processing devices; the memory 1204 can include multiple memory devices. A processing unit 1202 comprises a processor which is logic circuitry which responds to and processes instructions to provide the functions of the computer. A processing device can include one or more processing cores (not shown) that are multiple processors within the same logic circuitry that can operate independently of each other. Generally, one of the processing units in the computer is designated as a primary processor, typically called the central processing unit (CPU). One or more additional co-processing units 1220, such as a graphics processing unit (GPU), also can be present in the computer. A co-processing unit comprises a processor that performs operations that supplement the central processing unit, such as but not limited to graphics operations and signal processing operations.

The memory 1204 may include volatile computer storage devices (such as dynamic random access memory (DRAM) or other random access memory device), and non-volatile computer storage devices (such as a read-only memory, flash memory, and the like) or some combination of the two. A nonvolatile computer storage device is a computer storage device whose contents are not lost when power is removed. Other computer storage devices, such as dedicated memory or registers, also can be present in the one or more processors. The computer 1200 can include additional computer storage devices (whether removable or non-removable) such as, but not limited to, magnetically-recorded or optically-recorded disks or tape. Such additional computer storage devices are illustrated in FIG. 1 by removable storage device 1208 and non-removable storage device 1210. Such computer storage devices 1208 and 1210 typically are nonvolatile storage devices. The various components in FIG. 12 are generally interconnected by an interconnection mechanism, such as one or more buses 1230.

A computer storage device is any device in which data can be stored in and retrieved from addressable physical storage locations by the computer by changing state of the device at the addressable physical storage location. A computer storage device thus can be a volatile or nonvolatile memory, or a removable or non-removable storage device. Memory 1204, removable storage 1208 and non-removable storage 1210 are all examples of computer storage devices. Some examples of computer storage devices are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. Computer storage devices and communication media are distinct categories from each other, and both are distinct categories from signals propagating over communication media.

Computer 1200 may also include communications connection(s) 1212 that allow the computer to communicate with other devices over a communication medium. Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal. By way of example, and not limitation, communication media includes wired media, such as metal or other electrically conductive wire that propagates electrical signals or optical fibers that propagate optical signals, and wireless media, such as any non-wired communication media that allows propagation of signals, such as acoustic, electromagnetic, electrical, optical, infrared, radio frequency and other signals.

Communications connections 1212 are devices, such as a wired network interface, wireless network interface, radio frequency transceiver, e.g., WiFi 1270, cellular 1274, long term evolution (LTE) or Bluetooth 1272, etc., transceivers, navigation transceivers, e.g., global positioning system (GPS) or Global Navigation Satellite System (GLONASS), etc., transceivers, and network interface devices 1276, e.g., Ethernet, etc., or other device, that interface with communication media to transmit data over and receive data from signal propagated over the communication media.

The computer 1200 may have various input device(s) 1214, such as a pointer device, keyboard, touch-based input device, pen and tablet, light pen, camera, microphone, sensors, such as accelerometers, thermometers, light sensors and the like, and so on. A human input device is an input device that includes one or more devices that are responsive to manipulation by a human to provide a signal that is input to the computer. Such devices include but are not limited to switches (such as keyboard keys and mouse buttons), potentiometers (such as dials and knobs). Examples of a human input device include, but are not limited to, a keyboard, mouse, game controller, game pad, joystick, trackball, pen and tablet, light pen, and touchscreen. In some cases, a microphone can work as a human input device to the extent that audio signals are converted into other input events.

The computer 1200 may have various output device(s) 1216 such as a display, speakers, and so on. Such devices are well known in the art and need not be discussed at length here.

Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (EEG and related methods).

The various computer storage devices 1208 and 1210, communication connections 1212, output devices 1216 and input devices 1214 can be integrated within a housing with the rest of the computer, or can be connected through various input/output interface devices or ports on the computer, in which case the reference numbers 1208, 1210, 1212, 1214 and 1216 can indicate either the interface or port for connection to a device or the device itself.

Such an interface can be a physical port that connects the computer to external devices. Such an interface can be provided by a wireless connection, such as a Bluetooth connection. In some cases, the interface is provided by both a physical connection and a wireless connection. Any physical ports on a computer generally have a physical form factor that conforms to an established standard, or proprietary specification. Also, a protocol for communication between the personal computer and any external device connected to the port is typically implemented by a driver running on the personal computer. Examples of such ports include, but are not limited to, versions or types of a Universal Serial Bus (USB) port, a FireWire (IEEE-1394) port, a PS/2 serial port, a THUNDERBOLT port, and a Peripheral Component Interconnect (PCI) port, to name a few.

Some of these kinds of ports, such as USB ports, allow multiple different types of devices to be connected to a port. For example, both storage devices and input devices, such as keyboards and mouse devices, can be connected to a USB port of a computer. The protocols used by some kinds of ports, such as USB ports, allow for what is called a “plug and play” behavior. This means that, in response to a physical connection being made between the port of the computer and a device, the computer automatically executes an appropriate driver based on a type of the device, and immediately starts responding to any inputs from the device, without further intervention by the user.

A computer generally includes an operating system, such as a version of the WINDOWS operating system, a version of the LINUX operating system, a version of the ANDROID operating system, a version of the iOS operating system, a version of the MacOS operating system, a version of the UNIX operating system, or some other operating system. The operating system is a computer program that, when executed by a computer, manages access, by other processes (such as various system processes and user applications) running on the computer, to the various resources of the computer. There may be multiple processes. The various resources include the memory, storage, input devices and output devices, such as display devices, storage devices and input devices as shown in FIG. 1.

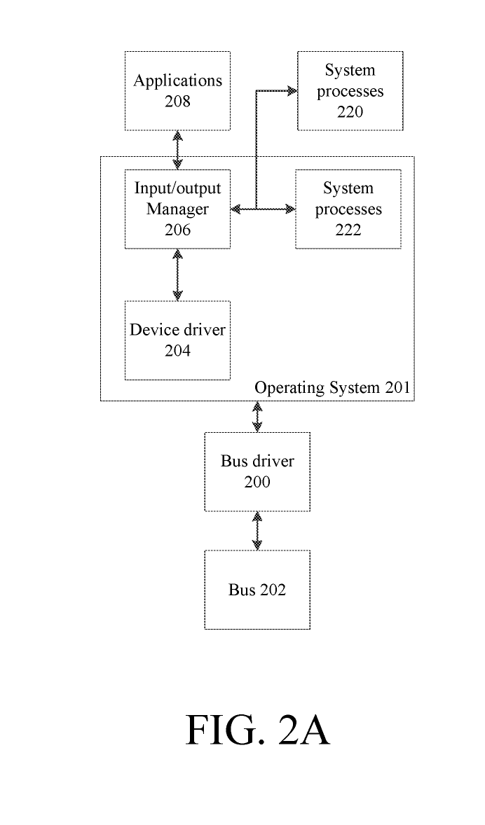

The various modules, tools, or applications, and data structures and flowcharts of FIGS. 2-6, as well as any operating system and applications on a computer in FIG. 1, can be implemented using the one or more processing units of the computers with one or more computer programs processed by the one or more processing units.

A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct or configure the computer to perform operations on data, or configure the computer to implement various components, modules or data structures.

Alternatively, or in addition, the functionality of one or more of the various components described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Turning now to FIG. 2A, an example implementation of an operating system for a computer, with respect to managing input devices connected to the computer through an interface such as a physical port, will now be described.

A computer generally includes at least one bus 202, a bus driver 200 for the bus, and a physical port, such as a USB port, connected to the bus. While FIG. 2A shows one bus, a computer can have multiple buses, and each bus typically has its own separate bus driver and port. The physical port provides a mechanical and electrical interface for connecting the computer, and bus 202, to a peripheral device. The bus driver 200 monitors the bus 202 for connection by a device to the physical port on the bus. In response to this connection, the bus driver notifies the operating system 201 of the existence of a device connected on the bus 202 and a type of the device. In response, the operating system 201 may start executing a process that implements a device driver 204 for that type of device. Such a process may already be executing, and may be associated with the newly connected device.

The operating system 201 also can include one or more input/output managers 206. An input/output manager stores and queues signals from multiple components of the computer, such as device driver 204, for processing by the operating system, which in turn directs such signals to appropriate other components of the computer for further processing, such as system processes 220, 222 and applications 208. For example, the input/output manager may direct output events from applications 208 or system processes 220, 222 to device drivers for output devices. As another example, the input/output manager may direct input events from device drivers for input devices to applications 208 or system processes 220, 222.

For example, a keyboard input event may be generated by a device driver 204, which is received by the input/output manager 206 and placed in an input event queue. The input/output manager processes the keyboard input event to determine how the keyboard input event should be further processed. For example, the input/output manager may determine that the keyboard input event should be directed to a running user process, such as particular application, such as a word processing application. As another example, the input/output manager may determine that the keyboard input event should be processed to start executing a new process, such as a command line interface. As another example, the input/output manager may determine that the keyboard input event should be directed to a running process such as a command line interface.

For the purposes of illustration in FIG. 2B, in one example implementation of the device driver 204, the device driver can be implemented using two or more components: e.g., a low-level filter driver 210 and a function driver 212. Such an implementation can be used in operating systems that support low-level filter drivers. For example, in the Windows operating system, a low-level filter driver monitors and/or modifies I/O requests for a device. Typically, such filter drivers redefine hardware behavior to match specifications. A lower-level per-class filter monitors and/or modifies I/O requests for a class of devices. For example, a lower-level class filter driver for mouse devices can provide acceleration and/or can perform a nonlinear conversion of mouse movement data. A function driver is a driver for a device which translates signals received from the device, through the bus driver and any low-level filter driver, into input requests in a form expected by the input/output manager 206, and translates output requests from the input/output manager 206 into signals to be transmitted, through the low-level filter driver and bus driver, to the device. Thus, in the Windows operating system, the verification of a human input device of a given type as described herein can be implemented in a low-level filter driver for that type of human input device.

In a computer with an operating system that does not support low-level filter drivers, such verification may be implemented in several ways. For example, in an implementation of a Linux operating system, a MacOS operating system or an iOS operating system, or a UNIX-based operating system, which does not support filter drivers, referring to FIG. 2C, a device driver 220 that communicates directly with the bus driver can be used to implement the verification of a human input device as described herein. For example, the device driver 220 for a device can be implemented to verify any newly connected device before allowing inputs from that device to be passed to other components. In response to connection of a new device, the device driver 220 enters a first state in which in performs verification, and only after verifying a device as a valid human input device does it transition to a second state in which in processes inputs normally.

As another example, as shown in FIG. 2D, in operating systems which support an I/O control messages which allows a process to take exclusive control of an I/O device, such as some implementations of a LINUX operating system, a first device driver 230 processes inputs from any newly connected device prior to those inputs being delivered to any other component in the computer. The first device driver 230 registers with an event manager (not shown) in the operating system for any event generated when a new device is connected to the computer. This event may be signaled by the device or the bus driver when the device is connected to the computer. The first device driver 230 can then issue a “EVIOCGRAB” I/O Control Message (ioctl) to take exclusive control of the device and perform the verification operations. After the verification operations are complete, and if the device is verified as a human input device, then the first device driver 230 releases exclusive control of the device, and control of the device transitions to a second device driver 232 for the device to manage I/O requests for the device.

In general, a device driver that communicates directly with the bus driver and receives inputs from the device through the bus driver before those inputs are allowed to be processed by any other component in the computer, can implement the verification of a human input device as described herein.

If an operating system of a computer supports plug and play behavior, in response to detecting that a new device has been connected to the computer, the operating system loads a device driver for that device, which in turn starts processing inputs from that device. An unaware user may believe that he or she has a storage device when connecting a device to a computer. Or, an individual with malicious intent may have a device that appears to be storage device or other apparently innocuous device which he or she connects to the computer. In either case, the device may be configured to behave as a human input device such as a keyboard, which, upon connection to the computer, begins sending a predetermined stream of commands, such as keyboard inputs, to the computer. This stream of commands can be designed to introduce malicious code into the computer.

To prevent such behavior, a device driver 204 for a human input device, by including a low-level filter driver 210, a first device driver 230 or device driver 220 with verification operations. In particular, a device driver 204 includes computer program instructions which validates a newly connected device as a human input device before allowing any input requests to be issued from the device to the input/output manager or other component of the computer.

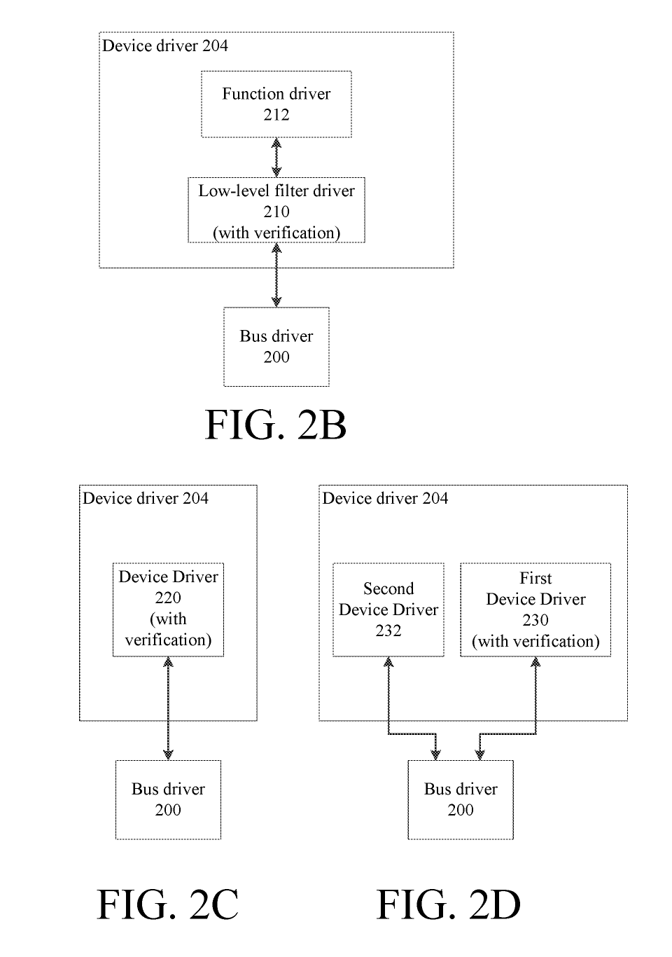

To perform such verification for a human input device, as an example implementation, when the device driver 204 begins operation, the device driver can first prompt the user to confirm that a type of the device as observed by the user (the “user-reported device type”) is the type of device as reported by the device (the “device-reported device type”, which is a human input device). If input from the user confirms that the user-reported device type matches the device-reported device type, then the device driver can begin passing input requests to the input/output manager or other components of the computer. Until the device driver makes such a confirmation, any input requests from a human input device can be dropped. If the new device is not confirmed to the device driver, e.g., a confirmation is not received in time, or a confirmation is not successful within a set number of attempts, or the device is expressly blocked, the device driver can ignore all further input/output requests for the device. Example implementations of such verification are described below in connection with FIGS. 3-6.

There are several ways to confirm that the user-reported device type matches the device-reported device type, i.e., to confirm that the connected device is a valid human input device.

For example, the device driver can direct the operating system to output a prompt to an output device connected to the computer, and wait for any input from any input device indicating that the user either accepts or rejects the newly connected device.

As another example, the device driver can direct the operating system to output a prompt to an output device connected to the computer, and wait for a specific kind of input from the newly connected device. For example, if the device type reported by the device is a “keyboard”, then the prompt can direct a user to enter a sequence of keystrokes through the device. If the device is not a keyboard, then entering the directed sequence of keystrokes would not be possible. The sequence of keystrokes can be randomly generated by the device driver at the time the device driver is invoked. A limit on the number of unsuccessful attempts, and/or a time limit, can be imposed for the directed sequence of keystrokes to be entered.

The device driver also can monitor inputs from a device and, based on heuristics of those inputs, such as speed of arrival of characters, and/or improbable inputs, or inputs in a pattern corresponding to system commands that may execute code. If the heuristics suggest the device may not be a valid human input device, the device driver can determine whether to continue processing inputs from the device, or to request verification of the input or of the input device. In some implementations, a device driver that monitors inputs from a device over time for this purpose can be a different device driver than the device driver that initially validates a device.

As another example, the device driver may have access to data describing approved devices. In some instances, a device may provide a serial number or other uniquely identifying information to the device driver. If such data is provided by a device, and the device driver can compare this data to a list of approved devices, then the device driver can use this information to determine whether to accept a new device.

Turning now to FIG. 3, a data flow diagram of an example implementation of such a system will now be described. A device 300 is connected to a bus, and writes signals 302 to and reads signals 302 from the bus. A bus driver 304 processes these signals and provides corresponding inputs to a device driver 310 and other components of the computer. The bus driver generates a device notification 306 when the device 300 is connected to the bus. The device notification generally indicates a type of the device, which enables a component of the computer (herein called the “plug and play manager” 308) to identify and load a corresponding device driver for that type of device. Such a component may be called different names in different operating systems.

In response to the device notification 306, the plug and play manager 308 identifies and loads code to instantiate a device driver 310 which performs verification for the corresponding device. Upon loading, the device driver 310 first generates a prompt 312, directing an input/output manager (“I/O manager”) 318 to cause a prompt to be presented on an output device 320. For example, the prompt 312 may specify data to be presented to a user. Such a prompt can be visual or aural, such as text to be presented on a display and/or one or more sounds to be played on a speaker. In turn, the I/O manager 318 directs the prompt to the corresponding output device 320.

The device driver then receives input data 314 or device input data 316. Input 314 may be data representing an input received by the computer from another device (not shown) and directed to the device driver through the I/O manager 318, to confirm that the device 300 is valid. Device input data 316 is input received from the new device. In response to the input data 314, or device input data 316, the device driver can determine whether to recognize the new device 300 as valid and process further device input data 316 (or allow another device driver to process further device input data 316).

In some implementations, a recognized device 300 may be added to stored data 322 indicating a set of valid devices. The device driver 310 can check whether data about the device, such as a serial number, which may have been received in the device notification 306, is in the stored data 322 indicating a set of valid devices. The stored data 322 can also include information about device data that may be suspicious or unreliable, such as a serial number of all zeros. The check can be performed prior to sending the prompt 312 to an output device. The result of this check can be used instead of issuing a prompt 312, or in addition to the input data 314, or device input data 316 in response to a prompt 312, to determine whether to recognize the new device 300 as valid. The prompt can indicate, or the content of the prompt can be modified based on, whether there is data about the device in the stored data 322. Information about a device that has been validated by the user also can be stored by the device driver in the stored data 322.

Additionally, the device driver 310 may track history information 330 about device input data 316 received from the device, validation attempts made with the device, or other information about the device. Such information can be used to evaluate whether to recognize the device as a valid human input device, or whether to continue to recognize a device as valid.

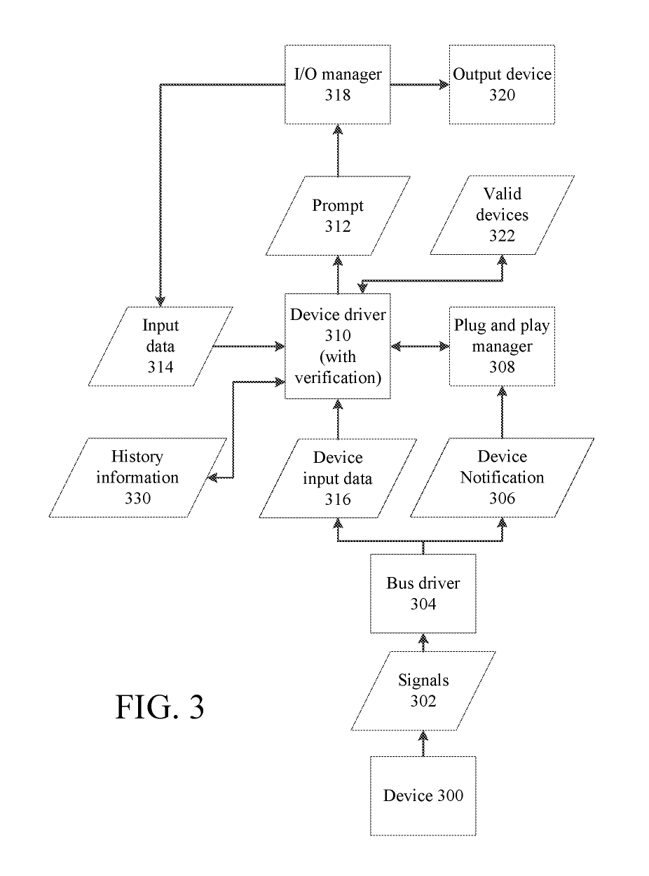

A flow chart illustrating operation of other operating system components in response to connection of a new device will now be described in connection with FIG. 4A. When a new device connects to a port, the operating system receives 400 a notification of connection of the new device. In response to this notification the operating system identifies and loads a device driver for the device. The operating system is configured to ensure that the device driver to be loaded and process the initial inputs from the newly connected input device is a device driver that performs verification, such as a low-level filter driver 210, device driver 220 or device driver 230, before the initial input from the newly connected input device are passed on to other components of the computer.

A flow chart illustrating operation of the example implementation of a device driver that performs verification will now be described in connection with FIG. 4B. The device driver initializes 400 and determines 402 whether to prompt the user to validate the device before allowing inputs from the device to be processed. For example, the device driver may check data available about the device against stored data about authorized devices. If the device driver determines to validate the device, a prompt is generated 404 and output to an output device; otherwise, the device driver proceeds with normal processing 414 of the inputs from that device. After a prompt is generated at 404, input data is then received 406. For example, the input may indicate whether a user has elected to block or accept the device, and/or has entered in a code through the device to validate the device. Based on this input data, the device driver determines 408 whether to block or accept the device. If the device driver determines to block the device, the blocking of the device may be communicated 410 to other components of the computer. The device driver can enter into a state in which it drops all further input signals from that device. If the device driver determines to accept the device, information, if available, about the device can be stored 412, indicating the device is validated. The device driver then can proceed with normal processing 414 of inputs from that device, such as by changing state or transitioning processing to another device driver.

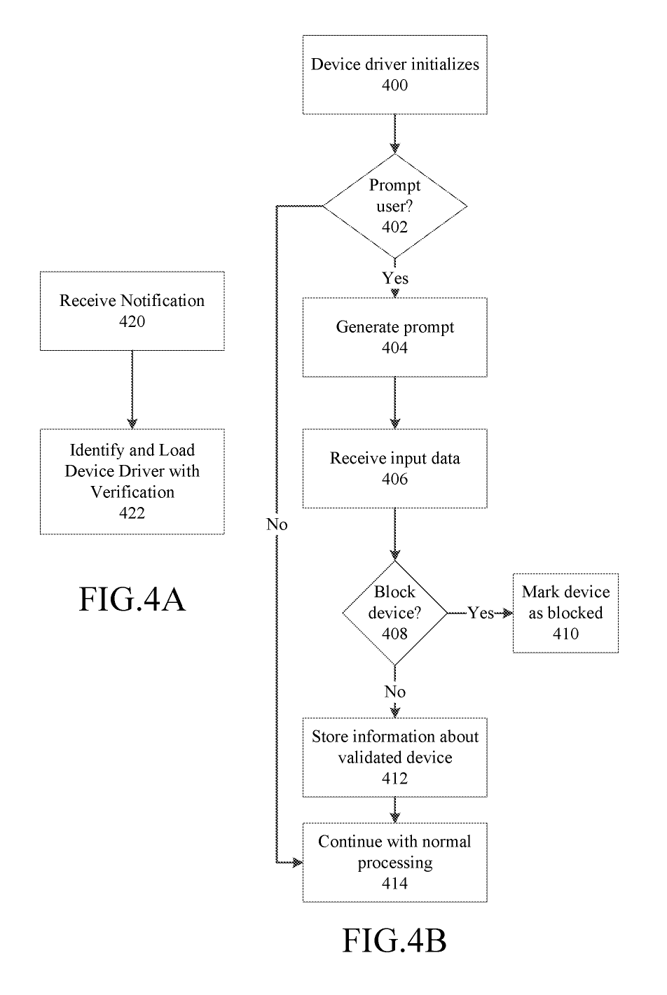

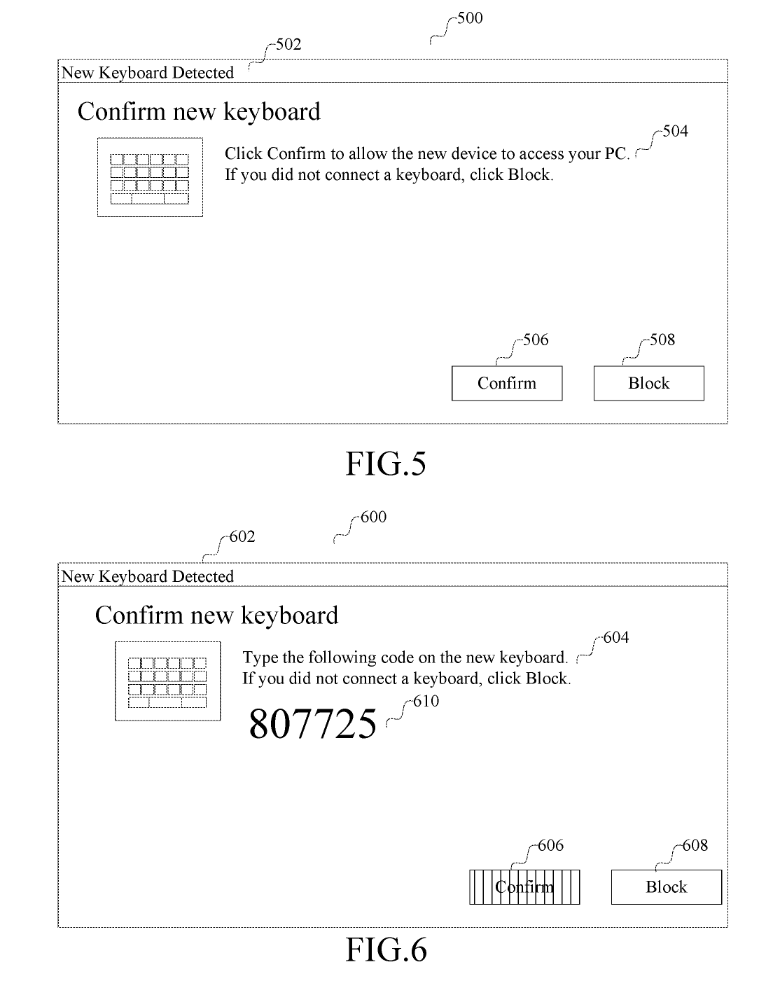

Example prompts that can be generated by a device driver will now be described in connection with FIGS. 5 and 6.

In FIG. 5, a prompt 500 is communicated to a display device including graphical data, text data and user interface input elements. In this prompt, text data 502 communicates to a user, “New Keyboard Detected”, and advises the user, “If you did not connect a keyboard, click Block.” at 504. A user interface input element, such as a button 508 marked “block” can be provided. In response to a gesture related to the “block” button 508 through a valid input device, such as a click from a mouse connected to the computer, the device driver can be instructed to block the newly detected keyboard. The text 504 in the prompt also can advise the user, “Click Confirm to allow the new device to access your PC.” A user interface input element, such as a button 506 marked “confirm” can be provided. In response to a gesture related to the “confirm” button, through a valid input device, such as a click from a mouse connected to the computer, the device driver can be instructed to confirm the newly detected keyboard. As an example implementation, the availability of the “confirm” button can be dynamic based on whether information available to the device driver about the new device suggests that the device is likely valid.

In FIG. 6, a prompt 600 is communicated to a display device including graphical data, text data and user interface input elements. In this prompt, text data 602 communicates to a user, “New Keyboard Detected”, and advises the user, “If you did not connect a keyboard, click Block.” at 504. A user interface input element, such as a button 608 marked “block” can be provided. In response to a gesture related to the “block button”, through a valid input device, such as click from a mouse connected to the computer, the device driver can be instructed to block the newly detected keyboard.

The text in the prompt 600 also can present a code 610 and the text 604 can instruct the user to enter the code through the new input device, such as “Type the following code on the new keyboard.” Any user interface input element that would otherwise allow the new device to be accepted, such as a button 606 marked “confirm”, can be presented but disabled. For example, the disabling of the “confirm” button can be done based on whether information about the new device available to the device driver, such as its serial number, suggests the device should be validated by input from the new device.

As one example, the code 610 can be an arbitrary number of alphanumeric characters, symbols or special keys, or key combinations, or instructions for an arbitrary sequence of inputs, based on the type of human input device that the new device is reporting to be. The sequence can be randomly generated for each time a prompt is presented. The presented code 610 can be compared to the actual input data received from the device. While receiving inputs in response to the prompt, the device driver can direct that the prompt be updated by highlighting which elements of the sequence have already been entered. A time limit can be applied for the user the enter the requested sequence of inputs. This time limit can be presented in the prompt 600. Additionally, a number of failures to input the requested sequence of inputs may be permitted to allow for human error. The number of available attempts can be presented in the prompt 600.

By having the operating system identify and load a device driver for a new device such that the device driver processes initial inputs from the new device until the device is verified as a human input device, inputs from the device are not passed to other components of the computer. Using such verification of a device driver that presents to the operating system as a human input device, the likelihood that the device can introduce malicious code into the computer is reduced.

Accordingly, in one aspect, a computer comprises an input port connected to a bus, and a processing system executing an operating system of the computer and connected to the bus. The operating system is operative to, in response to connection of a human input device to the input port, load a device driver to verify the human input device and direct inputs from the human input device to the device driver until the human input device is verified. The device driver is operative to communicate a prompt to an output device connected to the computer and receive input data. In response to the received input data, the device driver is operative to determine whether to validate the human input device. In response to determining not to validate the human input device, the device driver ignores further input from the input device.

In another aspect, a computer-implemented process is performed by an operating system of a computer. The computer includes a processing system executing the operating system, a bus connected to the processing system, and an input port connected to the bus. The computer-implemented process comprises, in response to connection of a human input device to the input port, loading a device driver to verify the human input device and directing inputs from the human input device to the device driver for processing by the device driver until the human input device is verified. Processing by the device driver comprises communicating a prompt to an output device connected to the computer and receiving input data. In response to the received input data, the device driver determines whether to validate the human input device. In response to determining not to validate the human input device, the device driver ignores further input from the input device.

In another aspect, a computer includes means for detecting connection of a new device to a port and means for validating the new device as a human input device before allowing input requests from the new device to be delivered to components of the computer for processing.

In any of the foregoing aspects, the operating system can be further operative to, in response to determining to validate the human input device, allow processing of further input data received from the human input device.

In any of the foregoing aspects, the received input data can indicate an instruction to block the human input device, and, to determine whether the validate the human input device, the operating system can be further operative not to validate the human input device.

In any of the foregoing aspects, the received input data can indicate an instruction to allow the human input device, and, to determine whether the validate the human input device, the operating system can be further operative to validate the human input device.

In any of the foregoing aspects, to determine whether to validate the human input device, the operating system can be further operative to compare the received input data to a validation condition, and, in response to comparing the received input data to a validation condition, determine whether to validate the human input device.

In any of the foregoing aspects, the operating system can include a bus driver and a device driver for the human input device. The device driver can be operative to determine whether to validate the human input device, and, in response to determining not to validate the human input device, ignore further input from the input device.

In any of the foregoing aspects, the received input data can include input received through the input port from the human input device.

In any of the foregoing aspects, the prompt can request input of a sequence of inputs through the human input device and the validation condition is the requested sequence of inputs being received through the input port from the human input device.

In any of the foregoing aspects, the operating system can be further operative to randomly generate the sequence of inputs after connection of the human input device to the input port.

In any of the foregoing aspects, after validating a human input device, the operating system can be operative to store information identifying the validated human input device. To determine whether to validate the human input device, the operating system can be operative to compare identifying information of the human input device to the stored information of validated human input devices.

In another aspect, an article of manufacture includes at least one computer storage medium, and computer program instructions stored on the at least one computer storage medium. The computer program instructions, when processed by a processing system of a computer, the processing system comprising one or more processing units and storage, configures the computer as set forth in any of the foregoing aspects and/or performs a process as set forth in any of the foregoing aspects.

Any of the foregoing aspects may be embodied as a computer system, as any individual component of such a computer system, as a process performed by such a computer system or any individual component of such a computer system, or as an article of manufacture including computer storage in which computer program instructions are stored and which, when processed by one or more computers, configure the one or more computers to provide such a computer system or any individual component of such a computer system.

It should be understood that the subject matter defined in the appended claims is not necessarily limited to the specific implementations described above. The specific implementations described above are disclosed as examples only.

What is claimed is:

1. A computer comprising:
an input port connected to a bus;
a processing system executing an operating system of the computer and connected to the bus, the operating system operative to:
in response to connection of a human input device to the input port, load a device driver to verify the human input device and direct inputs from the human input device to the device driver until the human input device is verified, wherein the device driver is operative to:
communicate a prompt to an output device connected to the computer;
receive input data;
in response to the received input data, determine whether to validate the human input device; and
in response to determining not to validate the human input device, ignore further input from the input device.

2. The computer of claim 1, wherein the operating system is further operative to:
in response to determining to validate the human input device, allow processing of further input data received from the human input device.

3. The computer of claim 2, wherein the received input data indicates an instruction to block the human input device, and, to determine whether the validate the human input device, the operating system is further operative not to validate the human input device.

4. The computer of claim 3, wherein the received input data indicates an instruction to allow the human input device, and, to determine whether the validate the human input device, the operating system is further operative to validate the human input device.

5. The computer of claim 2, wherein, to determine whether to validate the human input device, the operating system is further operative to:
compare the received input data to a validation condition; and
in response to comparing the received input data to a validation condition, determine whether to validate the human input device.

6. The computer of claim 5, wherein the operating system comprises a bus driver and a device driver for the human input device, and wherein, the device driver is operative to determine whether to validate the human input device, and, in response to determining not to validate the human input device, ignore further input from the input device.

7. The computer of claim 5, wherein the received input data includes input received through the input port from the human input device.

8. The computer of claim 7, wherein the prompt requests input of a sequence of inputs through the human input device and the validation condition is the requested sequence of inputs being received through the input port from the human input device.

9. The computer of claim 8, wherein the operating system is further operative to randomly generate the sequence of inputs after connection of the human input device to the input port.

10. The computer of claim 2, wherein, after validating a human input device, the operating system is further operative to store information identifying the validated human input device, and wherein, to determine whether to validate the human input device, the operating system is further operative to compare identifying information of the human input device to the stored information of validated human input devices.

11. A computer-implemented process, performed by an operating system of a computer, the computer including, a processing system executing the operating system, a bus connected to the processing system, and an input port connected to the bus, the computer-implemented process comprising:
in response to connection of a human input device to the input port, loading a device driver to verify the human input device and directing inputs from the human input device to the device driver for processing by the device driver until the human input device is verified,
wherein processing by the device driver comprises:
communicating a prompt to an output device connected to the computer;
receiving input data;
in response to the received input data, determining whether to validate the human input device; and
in response to determining not to validate the human input device, ignoring further input from the input device.

12. The computer-implemented process of claim 11, further comprising:
in response to determining to validate the human input device, allowing processing of further input data received from the human input device.

13. The computer-implemented process of claim 12, wherein the received input data indicates an instruction to block the human input device, and, wherein determining whether the validate the human input device comprises not validating the human input device.

14. The computer-implemented process of claim 13, wherein the received input data indicates an instruction to allow the human input device, and wherein determining whether the validate the human input device comprises validating the human input device.

15. The computer-implemented process of claim 12, wherein determining whether to validate the human input device comprises:
comparing the received input data to a validation condition; and
in response to comparing the received input data to a validation condition, determining whether to validate the human input device.

16. The computer-implemented process of claim 15, wherein the operating system comprises a bus driver and a device driver for the human input device, and wherein, the device driver is operative to determine whether to validate the human input device, and, in response to determining not to validate the human input device, ignore further input from the input device.

17. The computer-implemented process of claim 15, wherein the received input data includes input received through the input port from the human input device.

18. The computer-implemented process of claim 17, wherein the prompt requests input of a sequence of inputs through the human input device and the validation condition is the requested sequence of inputs being received through the input port from the human input device.

19. The computer-implemented process of claim 18, further comprising randomly generating the sequence of inputs after connection of the human input device to the input port.

20. The computer of claim 12, further comprising:
after validating a human input device, storing information identifying the validated human input device; and
wherein determining whether to validate the human input device comprises comparing identifying information of the human input device to the stored information of validated human input devices.
